(19) United States
(12) Patent Application Publication
(10) Pub. No.: US 2011/0265960 A1
(43) Pub. Date: Nov. 3, 2011

(54) Window Shade Apparatus

(76) Inventor: Robert S. LeBlanc, Kennesaw, GA (US)

(21) Appl. No.: 12/893,493

(22) Filed: Sep. 29, 2010

Related U.S. Application Data
(60) Provisional application No. 61/329,231, filed on Apr. 29, 2010.
(60) Provisional application No. 61/333,978, filed on May 12, 2010.

(51) Int. Cl. E06B 9/60; A47H 5/02

(52) U.S. Cl. 160/313; 160/340

(57) ABSTRACT

A cordless window shade apparatus including a headrail having a pulley affixed to the headrail, and a rod coupled to the pulley at one end of the rod. The cordless window shade apparatus also includes a window cover affixed at one end to the headrail and a lift fabric affixed at one end to the rod and at a second end to a bottom portion of the window cover. In addition the cordless window shade apparatus includes a plurality of crossbars removeably coupled to a rear surface of the window cover and a lift chain operably coupled to the pully. The lift fabric is positioned between the plurality of crossbars and the rear surface of the window cover and the window cover may be raised or lowered via the lift chain.

### CROSS REFERENCE TO RELATED APPLICATIONS

This application claims the benefit of and priority to U.S. provisional patent application Ser. No. 61/329,231 filed Apr. 29, 2010 and to U.S. provisional patent application Ser. No. 61/333,978 filed May 12, 2010.

### FIELD OF THE INVENTION

This invention relates generally to window coverings, and more particularly to an improved lift mechanism for a window shade.

### BACKGROUND

Window coverings, such as shades or blinds, typically have a horizontal or vertical covering to prevent sunlight from entering an area and to retain privacy. The covering, which is commonly in the form of slats or pleats, can hang vertically in the case of a vertical covering, or can extend horizontally from a headrail in the case of a horizontal covering. Many window coverings also include a bottom rail as well.

Typically in order to raise and lower the bottom rail relative to the floor, a looped cord extends from a point along the bottom rail through the slats and into the headrail. Two or more cords are often provided to raise or lower the window covering evenly. The window covering is raised or lowered by pulling or releasing the accessible portion of the cords. Inventions directed to minimizing or eliminating the possibility of entanglement in the cords are provided in U.S. Pat. Nos. 5,577,543, 6,044,523, 5,562,140 and 6,431,248. However, due to their weight, window coverings made of heavier materials present additional challenges in designing releasable cords that minimize the possibility of entanglement in the cords. Therefore, there is still a need in the art for an apparatus that reduces the dangers associated with cords on window blinds.

### SUMMARY OF THE INVENTION

It should be appreciated that the particular devices and methods illustrating the present invention are exemplary only and not to be regarded as limitations of the present invention.

Exemplary embodiments include a cordless window shade apparatus including a headrail having a pulley affixed to the headrail and a rod coupled to the pulley at one end of the rod. The cordless window shade apparatus also includes a window cover affixed at one end to the headrail and a lift fabric affixed at one end to the rod and at a second end to a bottom portion of the window cover. In addition the cordless window shade apparatus includes a plurality of crossbars removeably coupled to a rear surface of the window cover and a lift chain operably coupled to the pully. The lift fabric is positioned between the plurality of crossbars and the rear surface of the window cover and the window cover may be raised or lowered via the lift chain.

Exemplary embodiments also include a concealed cord window shade apparatus including a headrail having a pulley affixed to the headrail. The concealed cord window shade apparatus also includes a window cover affixed at one end to the headrail and a lift fabric affixed at one end to the headrail and at a second end to a bottom portion of the window cover. The lift fabric has a plurality of lift cords embedded within the lift fabric. The concealed cord window shade apparatus further includes a plurality of crossbars removeably coupled to a rear surface of the window cover wherein the lift fabric is positioned between the plurality of crossbars and the rear surface of the window cover. The lift cords are operably coupled with the pulley and the window cover may be raised or lowered via the lift cords.

### BRIEF DESCRIPTION OF THE DRAWINGS

These and other features, aspects, and advantages of the present invention will become better understood when the following detailed description is read with reference to the accompanying figures, wherein:

FIG. 1 shows an rear view of a window shade that includes an embodiment of a cordless roman shade in accordance with the present invention;

FIG. 2 shows a side view of the embodiment of FIG. 1;

FIG. 3 shows an rear view of a window shade that includes an embodiment of a roman shade with a concealed lift cord in accordance with the present invention; and

FIG. 4 shows a side view of the embodiment of FIG. 4.

### DETAILED DESCRIPTION

While this specification concludes with claims defining the features of the embodiments that are regarded as novel, it is believed that the improved window shade lift apparatus and other embodiments will be better understood from a consideration of the following description in conjunction with the drawing figures, in which like reference numerals are carried forward.

As required, detailed embodiments of the improved window shade lift apparatus are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiments herein.

The terms “a” or “an,” as used herein, are defined as one or more than one. The phrase “at least one of” as used herein, is defined as one or more than one. The term “another,” as used herein, is defined as at least a second or more. The terms “including” and/or “having,” as used herein, are defined as comprising (i.e., open language).

The improved window shade lift apparatus described herein provides a safety feature for a window shade, such as a roman shade, that prevents a user become entangled with a lift cord of a typical window shade. The improved window shade lift apparatus may be designed to function properly with a wide variety of designs of window shades, especially window shades constructed out of a heavier material, such as bamboo or wood.

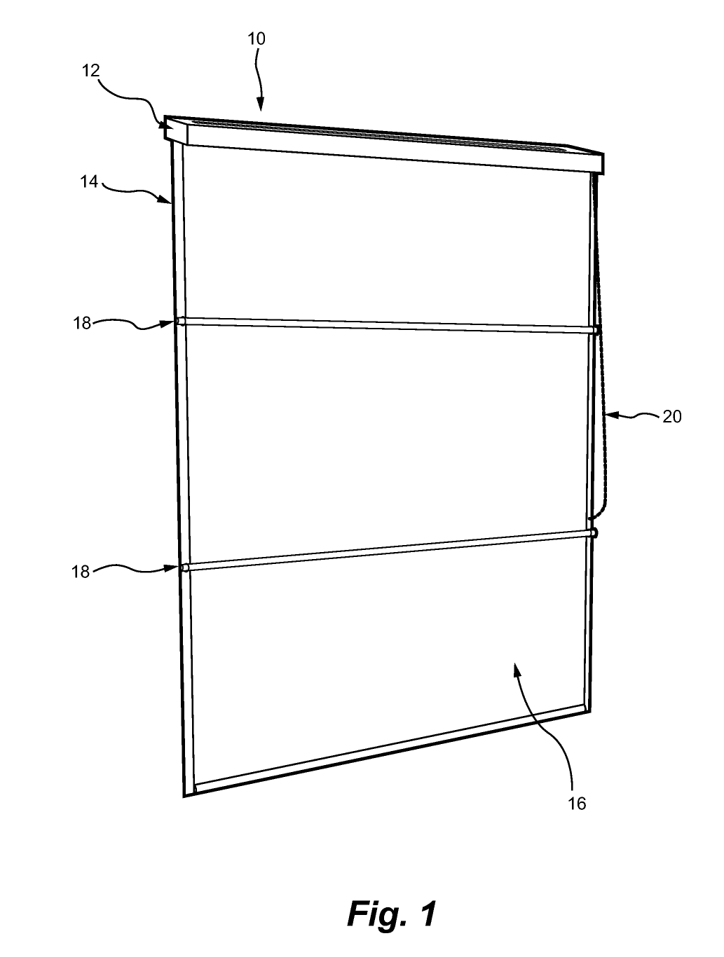

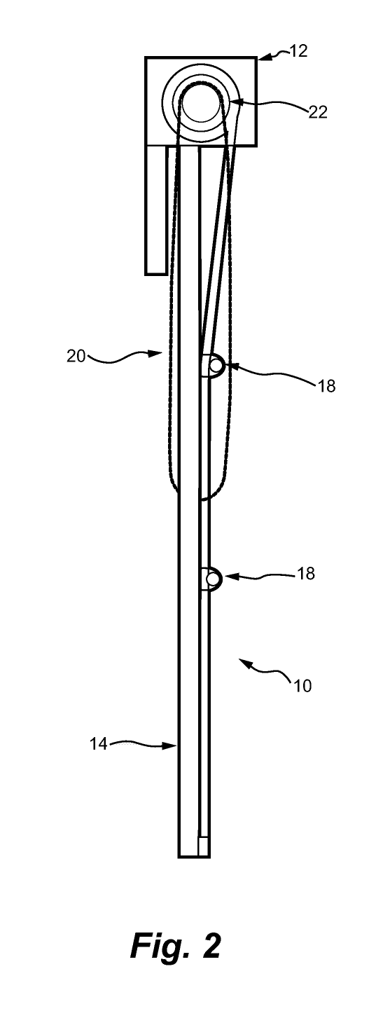

Referring now to FIGS. 1-2, an improved window shade lift apparatus is illustrated for a shade, such as a cordless window shade 10. The cordless window shade 10 includes a headrail 12, a window cover 14, a lift fabric 16, a plurality of crossbars 18, and a lift chain 20. The headrail 12 may include means for affixing the headrail 12 to a wall such a apertures for receiving screws. In other embodiments, the headrail 12 may be designed to be affixed to a wall through the use of a separate mounting mechanism. The headrail 12 includes a pulley 22 which may be removably affixed to the headrail such that at least a portion of the pulley 22 detaches from the headrail upon the application of a predetermined force in the downward direction. The headrail 12 also includes a rod coupled to the pulley 22 at one end of the rod.

The lift fabric 16 is affixed at its upper end to the rod and at its lower end to a lower end of the rear surface of the window cover 14. The window cover 14 is affixed at its upper end to the headrail 12. The lift fabric 16 extends from the bottom of the window cover 14 upwards toward the headrail 12 in between the rear surface of the window cover 14 and the plurality of crossbars 18.

Lift chain 20 is operably coupled with the pulley 22 such that a user can use the lift chain 20 to turn the rod, thereby raising or lowering the window cover 14. In exemplary embodiments, the lift chain 20 may be designed such that it will break when a predetermined amount of tension is applied to the lift chain 20. In additionally exemplary embodiments, the lift chain 20 may be coupled to a second pulley at a second point to restrict the freedom of movement of the lift chain 20. Furthermore, at least a portion of the pulley 22 is designed to detach and release the lift chain 20 upon the application of a predetermined force. These features, both separately and in combination, prevent a user from becoming entangled and injured by the lift chain 20.

In an exemplary embodiment, a portion of the pulley 22 is designed to detach and release the lift chain 20 upon the application of a force of three pounds and the lift chain 20 is designed to break upon the application of a tension force of five pounds. In this embodiment, at least a portion of the pulley 22 is designed to disengage before the lift chain 20 breaks. In other exemplary embodiments, the value of these forces could vary and the force required to disengage the pulley 22 could exceed the force required to break the lift chain 20.

In an alternative exemplary embodiment, the headrail 12 includes a spring loaded roller which is affixed to the rod. The spring loaded roller is used in place of the pulley 22 to raise and lower the widow cover 14. The rod is connected to the upper end of the lift fabric 16 and the lower end of the lift fabric 16 is connected to the lower end of the window cover 14. The lift fabric 16 extends from the bottom of the window cover 14 upwards toward the headrail 12 in between the rear surface of the window cover 14 and the plurality of crossbars 18. As the lift fabric 16 is retracted by the spring loaded roller the widow cover forms folds at each crossbar 18. In other exemplary embodiments the spring loaded roller may be similar to the window shade roller assembly disclosed in U.S. Pat. No. 4,373,569 to Barettella or another suitable apparatus.

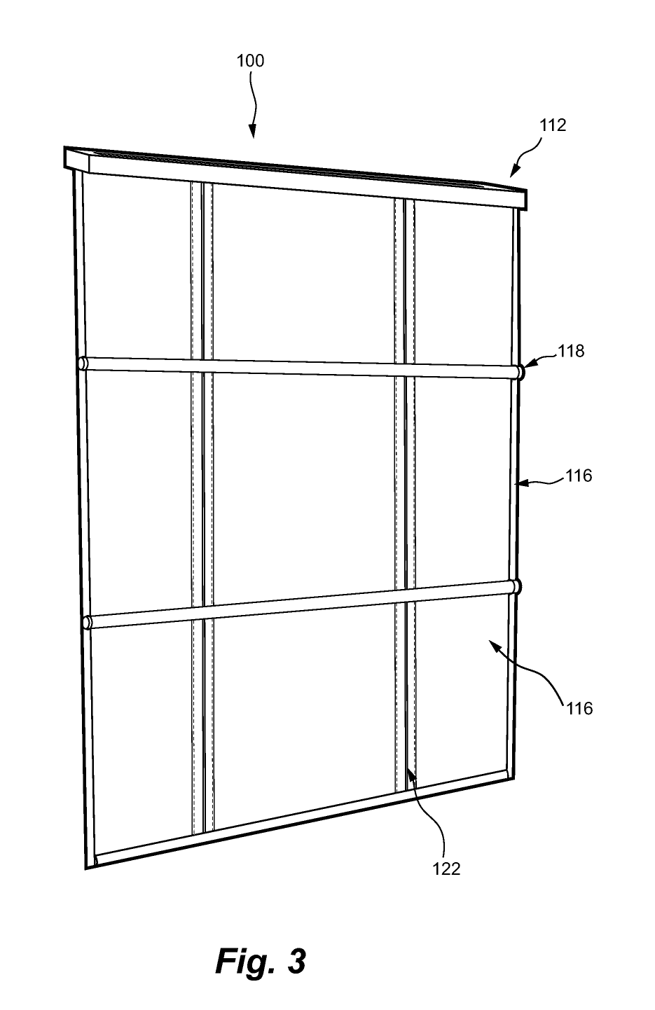

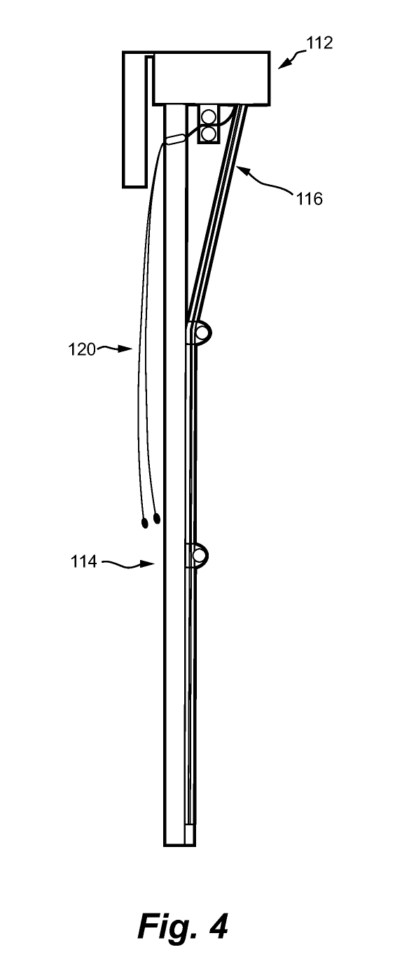

Referring now to FIGS. 3-4, an improved window shade lift apparatus is illustrated for a shade, such as a concealed cord window shade 100. The cordless window shade 100 includes a headrail 112, a window cover 114, a lift fabric 116, a plurality of crossbars 118, and one or more lift cords 120. The headrail 112 may include means for affixing the headrail 112 to a wall such as apertures for receiving screws. In other embodiments, the headrail 112 may be designed to be affixed to a wall through the use of a separate mounting mechanism. The headrail 112 includes a pulley 122 operably engaged to the lift cords 120.

The lift fabric 116 is affixed at its upper end to the headrail 112 and at its lower end to a lower end of the rear surface of the window cover 114. The window cover 114 is also affixed at its upper end to the headrail 112. The lift fabric 116 extends from the bottom of the window cover 114 upwards toward the headrail 112 in between the rear surface of the window cover 114 and the plurality of crossbars 118. The lift fabric 116 includes a plurality of channels 122 that are designed to receive the lift cords 120. The lift cords 120 are affixed at one end to the lower portion of the lift fabric 116. The channels 122 prevent the lift cords 120 from being exposed and thereby prevent a user from becoming entangled and injured by the lift cords 120.

In order to raise or lower the window cover 114, a user pull on the free end of the lift cords 120. The pulley 122 also includes a locking mechanism that allows the user to fix the height of the window cover 114 at a desired level.

In exemplary embodiments, the crossbars 20, 118 are removably affixed to the window cover 14, 114 and the number of crossbars 20, 118 can be varied by the user. By varying the number and placement of crossbar 20, 118, the user can customize the number and position of the folds that the window cover 14, 114 have when it is in a lifted position.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A cordless window shade apparatus comprising:
a headrail comprising:
a pulley affixed to the headrail; and
a rod coupled to the pulley at one end of the rod;
a window cover affixed at one end to the headrail;
a lift fabric affixed at one end to the rod and at a second end to a bottom portion of the window cover;
a plurality of crossbars removeably coupled to a rear surface of the window cover; and
a lift chain operably coupled to the pully,
wherein the lift fabric is positioned between the plurality of crossbars and the rear surface of the window cover and wherein the window cover may be raised or lowered via the lift chain.

2. The cordless window shade apparatus according to claim 1, wherein the lift chain is designed to break upon the application of a specified tension force.

3. The cordless window shade apparatus according to claim 1, wherein at least a portion of the pulley detaches from the headrail upon the application of a specified force.

4. The cordless window shade apparatus according to claim 2, wherein at least a portion of the pulley detaches from the headrail upon the application of a specified force.

5. A concealed cord window shade apparatus comprising:
a headrail comprising a pulley affixed to the headrail;
a window cover affixed at one end to the headrail;
a lift fabric affixed at one end to the headrail and at a second end to a bottom portion of the window cover, the lift fabric comprises a plurality of lift cords embedded within the lift fabric;
a plurality of crossbars removeably coupled to a rear surface of the window cover;
wherein the lift fabric is positioned between the plurality of crossbars and the rear surface of the window cover;
the lift cords are operably coupled with the pulley; and
wherein the window cover may be raised or lowered via the lift cords.

6. A cordless window shade apparatus comprising:
a headrail comprising:
a spring loaded roller apparatus affixed to the headrail; and
a rod coupled to the spring loaded roller apparatus;
a window cover affixed at one end to the headrail;
a lift fabric affixed at one end to the rod and at a second end to a bottom portion of the window cover; and
a plurality of crossbars removeably coupled to a rear surface of the window cover;
wherein the lift fabric is positioned between the plurality of crossbars and the rear surface of the window cover and wherein the window cover may be raised or lowered via tension on the window cover.
